(19) United States
(12) Patent Application Publication
(10) Pub. No.: US 2007/0162200 A1
(43) Pub. Date: Jul. 12, 2007

(54) Method and device for controlling the torque of a hybrid vehicle

(76) Inventors: Michael Zillmer, Sickte (DE); Matthias Holz, Lehre (DE); Ekkehard Pott, Gifhorn (DE); David Prochazka, Libosovice (CS)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/539,416

(22) Filed: Oct. 6, 2006

(30) Foreign Application Priority Data
Oct. 6, 2005 (DE) 10 2005 047 940.5

(51) Int. Cl. B60L 9/00

(52) U.S. Cl. 701/22

(57) ABSTRACT

In a method for controlling the torque of a motor vehicle having a hybrid drive unit (10), with the electric engine (14) providing a positive and/or negative torque (M_EM), when a requested torque (M_W) is given, that is stronger than an actually provided total driving torque (M_Fzg), (a) in an initial boost phase (B) a dynamic, positive torque (M_EM) of the electric engine is impressed on the torque (M_VM) of the internal combustion engine, which passes through a maximum during the boost phase (B), and (b) in a second phase (S, L) for a predetermined duration a predetermined, essentially constant, positive or negative torque (M_EM) of the electric engine is impressed on the torque (M_VM) of the internal combustion engine so that the resulting total driving torque (M_Fzg) is at least almost equivalent to the requested torque (M_W), with the algebraic signs and/or the strength of the torque (M_EM) of the electric engine being preset depending on the requested torque (M_W).

### PRIORITY

This application claims priority from German Patent Application No. DE 10 2005 047 940.5, which was filed on Oct. 6, 2005, and is incorporated herein by reference in its entirety.

### TECHNICAL FIELD

The invention relates to a method for controlling a driving torque of a motor vehicle having a hybrid drive unit, which comprises an internal combustion engine and additionally at least one electric engine that can optionally be run either by a motor or a generator operation, with the electric engine providing a negative torque in the generator operation and in the motor operation a positive torque of the electric engine, and the torque of the electric engine together with a torque of an internal combustion motor represent the total driving torque of the drive unit. Further, the invention relates to a hybrid vehicle with a respective torque control.

### BACKGROUND

The term hybrid vehicle defines motor vehicles, in which at least two drive units are combined with one another, which are using different energy sources in order to provide power for driving the vehicle. The features of an internal combustion engine, creating kinetic energy by burning gasoline or diesel fuel, cooperates in a particularly advantageous manner with an electric engine converting the electric energy into kinetic energy. Present hybrid vehicles are therefore overwhelmingly provided with a combination of an internal combustion engine and one or more electric engines. Two different hybrid concepts can be distinguished. In the so-called serial hybrid concepts the vehicle drive occurs exclusively by the electric engine, while the internal combustion engine via a separate generator creates the electric current for charging an energy storage unit feeding the electric engine and/or directly feeding the electric engine. However, today parallel hybrid concepts are preferred at least in passenger vehicles, in which the vehicle drive can be provided either by the internal combustion engine or by the electric engine.

The engines used in such parallel concepts can optionally be operated by a generator or an engine. For example, the electric engine is added for supporting the internal combustion engine during the motorized operation, typically at operating times of increased vehicle load. Additionally, it can accept the function of a starter motor for the internal combustion engine. However, the electric engine is primarily operated in generator mode when the drive is provided by the internal combustion engine, in which the generated electric power of the electric engine created in this manner is used, for example, for charging the energy storage and/or for feeding the vehicle power. In the event of a power-ramified hybrid concept having more than one electric engine, the generator operation of an electric engine can also be used for feeding another one. Further, in general at least a portion of the braking power is created by the electric engine operating in generator mode (recuperation), with some portion of the mechanical energy loss being converted into electric energy. Here, it is generally advantageous in hybrid concepts that the electric engine operates with a better effectiveness than conventional claw pole generators.

The object of the control of the so-called boost function, i.e., the supporting parallel use of the electric engine, in order to increase the overall driving torque of the hybrid drive, for example, is to achieve, on the one hand, a considerable improvement of the driving performance, but on the other hand also to provide a reproducible driving behavior without any negative effects on the driving performance, for example in the form of varying torque or “low torque.” The boost function requires high electric power of the electric energy storage of the electric engine. Based on the limited power of the energy storage—the energy unit of an electric energy storage is typically equivalent to only a fraction of the energy stored in a fuel tank—suitable strategies for using said boost function are necessary. Here, particularly the energy storage with its low energy content, for example a condenser storage, creates particularly high requirements to the control.

### SUMMARY

Therefore, the object of the present invention is to provide a method for coordinating the torque of an internal combustion engine and an electric engine, ensuring an efficient and demand-oriented use of the supporting, driving torque of the electric engine, when the driver requires a certain torque. Further, a suitable torque control device is to be provided for performing the method.

This object can be attained in a method as well as torque control providing for the torque requested by the driver, i.e., when a desired torque request exists, that is greater than the driving torque of the drive unit already provided,
in an initial boost phase to the moment of the internal combustion engine with a dynamic positive torque of the electric engine, which passes through a maximum during the boost phase, and
in a second phase, for a predetermined duration, a predetermined, essentially constant positive or negative torque of the electric engine to be impressed onto the moment of the internal combustion engine, so that the resulting total driving torque is at least approximately equivalent to the desired torque, in which the algebraic sign and/or the strength of the torque of the electric engine is predetermined depending on the requested torque.

### BRIEF DESCRIPTION OF THE DRAWINGS

In the following, the invention is explained in greater detail using exemplary embodiments shown in the corresponding figures. They show

FIG. 1 schematically the structure of a hybrid drive unit according to the invention;

FIG. 2 temporal progressions of a torque of an internal combustion engine and an electric engine, a total driving torque of a hybrid drive according to FIG. 1, as well as a desired torque according to the present invention at a maximum torque requested and a maximum pedal value (full acceleration);

FIG. 3 temporal progression of the torque described in FIG. 2 at a maximum torque requested and a non-maximum pedal value (high load);

FIG. 4 temporal progressions of the torque according to FIG. 2 at partial load.

### DETAILED DESCRIPTION

By the impression of the dynamic positive torque of the electric engine onto the increasing torque of the internal combustion engine during the initial boost phase, a faster and relatively homogenous increase of the total driving torque is achieved. By the torque of the electric motor passing a maximum, i.e., having an initially rising and then falling progression during the boost phase, the torque of the internal combustion engine rising over-proportionally is essentially supplemented in a linearly leveling manner. Due to the fact that in the second phase algebraic signs and/or the strength of the torque of the electric engine are predetermined depending on the requested torque, in particular depending on a difference of the requested torque and the driving torque provided by the internal combustion engine, a particularly well adapted use of the electric engine to the demand occurs, which considers the limited energy content of the energy storage.

Here, within the scope of the present invention, the term “impression of the torque of the electric motor” defines the addition of a positive (motorized) torque of the electric engine to the torque of the internal combustion engine and/or the reduction of the overall driving torque by subtracting the negative “recuperation torque” of the electric engine when it is operated by the generator.

The invention uses the circumstance that, based on its typical torque characteristic, the electric engine can be used in the lower rotation range, which typically extends in the listed hybrid drives up to a limit of rotation amounting to approximately 3000 to 3500 min⁻¹, in order to effectively increase the driving performance. In contrast thereto, internal combustion engines have a relatively low torque in the lower rotations. This is particularly true for charged internal combustion engines, which are supplied with compressed combustion air via a turbo charger. Those engines have a so-called “turbo hole,” in particular in the dynamic operation at low rotations, with typical values being below 2000 to 3000 min⁻¹, which ideally can be compensated by the torque of the electric engine. The present invention is therefore particularly well suited for the use in case of charged internal combustion engines. In principle, it can also be advantageously used for any other internal combustion engine in combination with an electric engine.

In one embodiment of the invention, essentially three boost functions are distinguished in three different scenarios. In the first case, a very high pedal value of the pedal value indicator (accelerator) is given, having at least 90%, particularly at least 95%, preferably approximately 100% prior and simultaneously to the desired torque, which is greater than the maximum torque of the internal combustion engine, in particular a maximum desired torque. In said first scenario, which occurs for example during take-over maneuvers at already high speed levels, a supplementary use of the electric engine is attempted, which is as strong as possible and as long lasting as possible.

In the second scenario another requested torque is given, which exceeds the maximum torque of the internal combustion engine, however, here the accelerator is not pressed entirely to the limit, i.e., the pedal value does not reach the limit mentioned in the first scenario. In this case, in the initial boost phase as well as in the subsequent second phase a strong to maximum support of the total driving torque also occurs by the electric engine, however, the overall duration of the support by the electric motor is shorter than in the first scenario.

Finally, according to the third scenario, again the driver requests a torque, however the resulting desired torque is lower than the maximum torque of the internal combustion engine. Typically, the pedal value in such situations is equivalent to a relatively low value, for example, it is lower than a level of 50%, preferably 40%, particularly preferred 30% of the maximum pedal value. In this phase, in the initial boost phase a dynamic support by the electric engine occurs as well, although with a lower supportive torque. Due to the fact that subsequently the requested torque can be provided by the internal combustion engine alone, no additional support is given by the electric engine, either by it being disconnected from the torque or deactivated or being operated as a generator, if necessary.

According to an embodiment of the invention the second phase is performed as a support phase, i.e., the electric engine is operated in engine mode with a positive torque of the electric motor if the desired torque is greater or equal to a maximum torque of the internal combustion engine. This case is given in the first of the two described case situations. On the one hand, if the desired torque is less than the maximum torque of the internal combustion engine (scenario 3) the second phase is performed as a charging phase, in which the electric engine is operated as a generator with a negative torque of the electric engine, or in a neutral phase, in which the electric engine is switched to operate without torque and/or deactivated. This occurs depending on a charge and/or aging condition of the energy storage, as well as by the actual need of vehicle power.

Another embodiment of the invention provides for the duration of the second phase and/or the intensity of the moment of the electric engine to be predetermined depending on the state-of-charge and/or the state-of-health of the electric energy storage of the electric engine and/or depending on an actual rotation of a particularly common camshaft of the hybrid drive unit. This way, the use of the electric engine is adjusted, on the one hand, by the request of the driver and limited, on the other hand, by the condition of the energy storage, i.e., the capabilities.

In the event the requested torque is greater than the maximum torque of the internal combustion engine, in particular is equivalent to the maximum, and simultaneously a pedal value amounts to 90 to 100%, preferably 95 to 100%, and particularly preferred approximately 100%, another advantageous embodiment of the invention provides that subsequent to the second phase a neutral phase is performed, in which the electric engine is operated with zero torque, and/or is deactivated. This way, the provided maximum torque of the internal combustion engine is passively supported by the electric engine, in which no braking torque of the electric engine operating as a generator reduces the overall driving torque.

The torque control according to the invention can be defined in a digital program algorithm, which is preferably stored in a hybrid control or in an expanded motor or transmission control, which in the case of a requested torque executes the previously described steps of the method according to the invention.

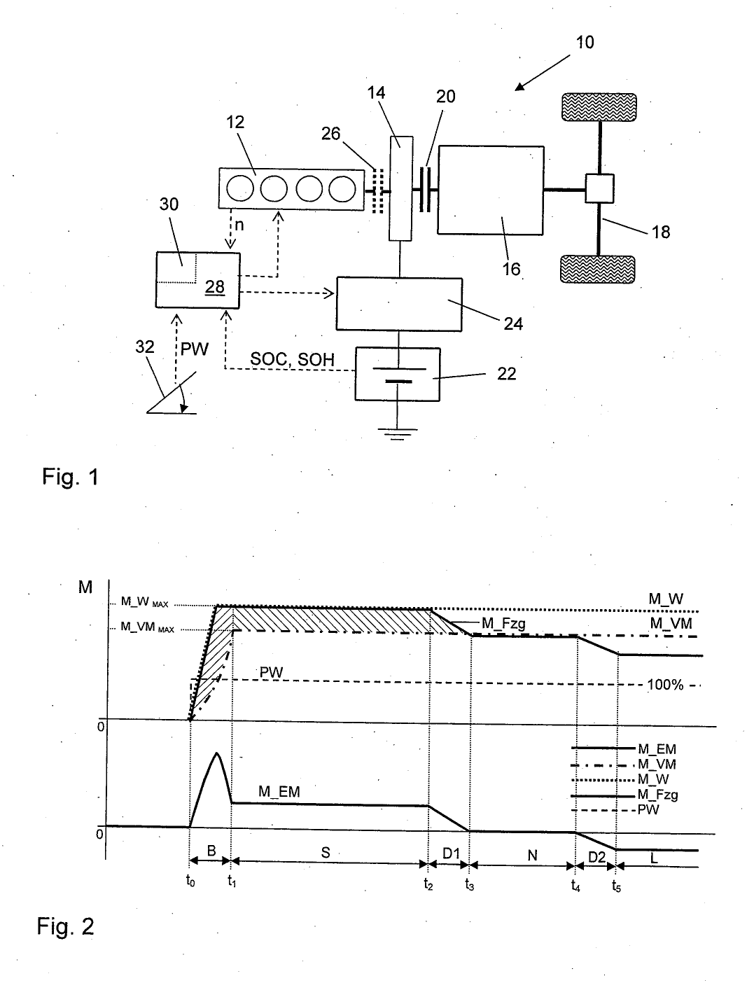

In FIG. 1, 10 marks in its entirety a parallel hybrid drive unit of a hybrid vehicle not shown in any detail. The drive of the vehicle occurs optionally or simultaneously by a conventional internal combustion engine 12 (gasoline or diesel motor) as well as an electric motor 14 (electric engine, E-engine), both of which affect the same shaft, in particularly the camshaft of the internal combustion engine 12. The internal combustion engine 12 is supplied with compressed charging air via a charger, not shown, in particular an exhaust turbo-charger. The connection of the electric engine 14 to the motor camshaft can occur in various manners. For example, the electric engine 14 can be directly connected to the camshaft or indirectly via a clutch or via a belt drive, for example a toothed belt, or a transmission or another force fitting and/or form fitting connection. The internal combustion engine 12 and the electric engine 14 are connected to an indicated drive lane 18 via a transmission 16. The decoupling of the drive shafts of the internal combustion engine 12 and/or the electric engine 14 from the transmission 16 occurs via a clutch 20, which can be opened by the driver by operating a clutch pedal, not shown, and remains closed when not being operated. The transmission 16 can alternatively be embodied as an automatic transmission, in which the operation of the clutch 20 is omitted. In particular, the transmission 16 can be embodied as a double-clutch transmission, in which the control and operation of the two clutches occurs automatically.

The electric engine 14, which is for example a rotating current-induction motor or rotating current-synchronous motor, can optionally be operated in a motorized operation with a positive or in the generator operation with a negative torque M_EM of the electric engine. In the motorized operation the electric engine 14 drives a drive lane 18, alone or supporting the torque M_VM of the internal combustion engine 12, consuming electric energy (current). The electric engine 14 draws said current from an energy storage 22, which may be, for example, a battery and/or preferably a condenser storage. However, in the generator operation the electric engine 14 is driven by the internal combustion engine 12 and/or a boost of the vehicle and transfers the kinetic energy into electric energy for charging the energy storage 22. The conversion of the electric engine 14 from motorized to generator operation occurs by a power electronic 24, which simultaneously performs a perhaps necessary switching between direct current and alternating current.

According to the concept shown, the vehicle drive occurs primarily by the internal combustion engine 12, which is started by the electric engine 14 embodied as a starter generator. The electric engine 14 additionally accepts the boost function by being switched on additionally to the vehicle drive (motorized operation) during high load situations, in particular during the acceleration of the vehicle. On the other hand, the electric engine 14 has a so-called recuperation function in drive situations, in which an excess of kinetic energy of the vehicle is given, by transferring the kinetic energy into electric energy in the generator operation for charging the energy storage 22 and thus simultaneously provides a braking moment. In this context a particularly suitable electric engine 14 is provided with a power of no more than 50 kW, in particular no more than 30 kW, preferably in the range from 15 to 25 kW, especially of approximately 20 kW.

In FIG. 1, additionally an optionally additional coupling 26 is indicated, which can be arranged between the internal combustion engine 12 and the electric engine 14. Such an additional coupling 26 allows the separate decoupling of the internal combustion engine 12 from the drive lane 18 and/or the electric engine 14, which generally leads to the advantage that an internal combustion engine 12 being switched off is not required to maintain its mechanical friction. Therefore, the additional coupling 26 causes an additional fuel savings potential, however, it is connected to additional cost, construction, and constructive space requirements. The present method described can also be used for hybrid drives with or without any additional couplings 26.

The control of the operation of the internal combustion engine 12 as well as the power electronic 24 occurs here by a motor control device 28, in which a torque control (indicated by 30) in the form of a program algorithm is integrated. Alternatively, the torque control 30 may also be provided in a separate control unit. Different actual operational parameters of the vehicle influence the torque control 28. In particular, a camshaft rotation n as well as a pedal value PW or a pedal value sensor indicated by 32 is provided for the control device 28. The pedal value PW shows the position of the accelerator, i.e., the amount of engagement of the accelerator by the driver. Furthermore, the motor control device 28 receives or determines information characterizing a state-of-charge (SOC) as well as a state-of-health (SOH) of the energy storage 22.

Depending on the pedal value PW and the rotation n the moment control 30 determines an actually requested torque M_W from saved parameters and controls both the torque M_VM of the internal combustion engine 12 as well as the torque M_EM of the electric engine 14 accordingly. In particular in phases in which the requested desired torque M_W exceeds an actually existing total driving torque M_Fzg of the hybrid drive unit 10, i.e., during load, for example in accelerating situations, the present invention is used. Here, depending on the determined requested torque M_W a case is determined, which leads to different strategies, which are shown in FIGS. 2 through 4 using the progression of the different moments.

In FIG. 2 a situation is shown in which at the time t₀ the pedal value sensor 32 shows a pedal value PW amounting to 100%, i.e., the accelerator is maximally engaged (“full speed”). Depending on the pedal value and an actual motor rotation index n, not shown, the motor control 28 determines a maximum desired torque (M_W=M_Wmax), which is always greater than a maximally permissible torque M_Vmax of the internal combustion engine. In this full speed situation, the moment M_VM of the internal combustion engine is supported by a maximum boost of the electric engine 14. For this purpose, an initial boost phase B of the internal combustion engine 12 with a maximum speed is accelerated up to its maximum torque M_VMmax. Simultaneously the electric engine 14 is dynamically operated during the boost phase B, with it initially being accelerated as fast as possible and subsequently being cut down so that the torque M_VM of the internal combustion engine is impressed by a dynamic, passing a maximum, positive torque M_EM of the electric engine. The result is a maximally fast and essentially linearly increasing total driving torque M_Fzg of the hybrid drive 10, which reaches the requested, desired torque M_W as early as during the boost phase B.

The boost phase B ends when the internal combustion engine 12 has reached its maximum torque M_VMmax (time t₁). Then, a subsequent support phase S is switched, while the internal combustion engine 12 continues to be operated at its maximum torque M_VMmax and is supported by an also at least almost constant positive torque M_EM of the electric engine 14. The strength of the supporting torque M_EM of the electric engine is here selected primarily such that the resulting total driving torque M_Fzg is essentially equivalent to the desired torque M_W. Additionally, the torque V_EM as well as the duration of the quasi-static support phase S are given dependent on the rotation n as well as the present charging and aging condition SOC, SOH of the energy storage 22. For example, when a low charging level is given and the storage capacity has already been influenced by strong aging, a tendency of shorter duration of the support phase is determined. When the available electric energy of the storage 22 is very low, a lower torque M_EM can also be controlled, accepting that the requested torque M_W cannot be implemented in its entirety.

After the predetermined duration of the support phase S has ended at the time t₂ the torque M_EM of the electric engine is addressed during a first downward control phase D1 with a defined change of torque until at least an almost zero-torque is reached. This occurs by reducing and subsequently switching off the exciter via the power converter. During the subsequent neutral phase N the zero-torque of the electric engine 14 is maintained and thus the internal combustion engine 12 is passively supported. In this phase N the internal combustion engine 12 is neither supported nor loaded by the electric engine 12. It must be mentioned that in permanently excited synchronized machines generally no zero-torque can be adjusted, but here a low drag moment develops, which in the present document is included in the term zero-torque. The neutral phase N is preferably only performed in the case of maximum load demand, for example during short accelerations at already high vehicle speeds. Accordingly, a strong desired torque M_W is provided as a criterion for performing the neutral phase N, which is particularly stronger than the maximum torque M_VMmax of the internal combustion engine, preferably similar or equal to the maximum desired torque M_Wmax. Simultaneously, a pedal value PW of at least 90%, particularly at least 95%, preferably a maximum pedal value of at least approximately 100% must be provided. The duration of the neutral phase N can also be predetermined depending on SOC and/or SOH of the energy storage 22.

At the end of the neutral phase N, at the time t₄, another downward control phase D2 of the moment M_EM is controlled downward to a negative value with a defined torque change, i.e., the electric engine 14 runs in generator mode. Here, during the subsequent charging phase L the generating torque M_EM was selected such that a vehicle power is just covered, i.e., the energy storage 22 is not being charged due to a lack of excess energy. This way, on the one hand, the electric vehicle power is ensured and, on the other hand, the braking moment created in this manner is minimized. Depending on the charge condition SOC of the energy storage 22 and/or a conventional vehicle battery, as well as the present requirements of the energy management, the negative moment M_EM of the electric engine can be lowered even more during further progression, in order to cause charging of the energy storage 22 and/or of the battery.

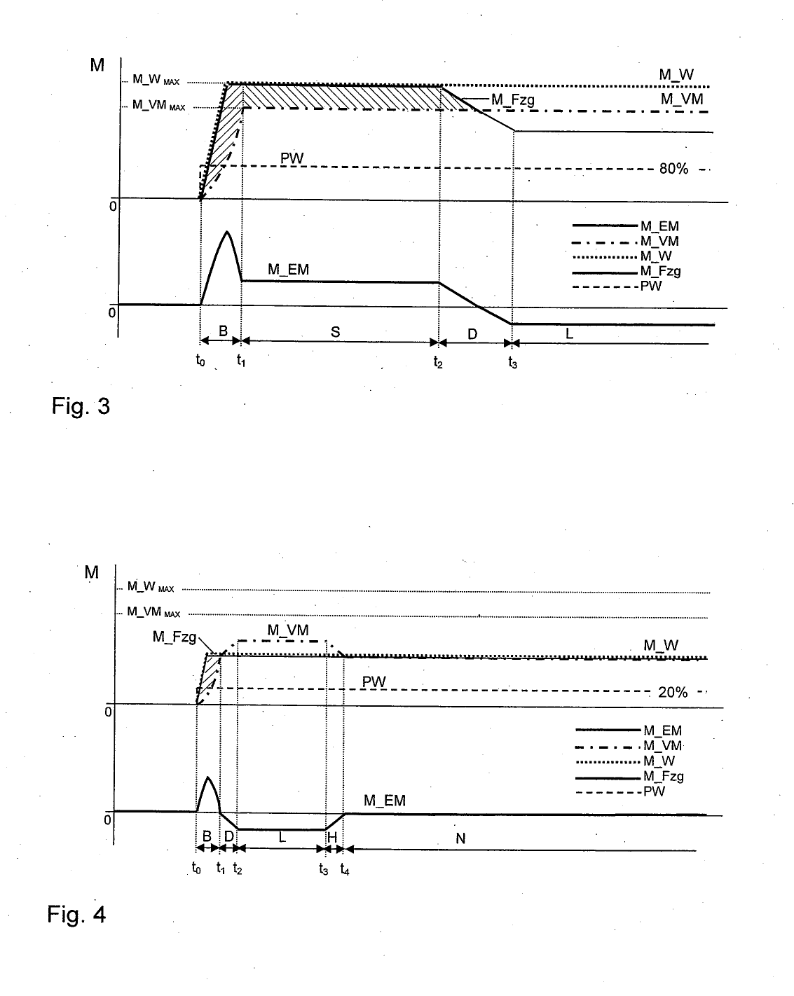

The situation shown in FIG. 3 also provides a desired torque M_W, which exceeds the maximum torque M_VMmax of the internal combustion engine, in particular a maximum desired torque M_Wmax is given. However, in contrast to FIG. 2, the pedal value PW is smaller than 100% and amounts here to 80% of the maximum pedal value. In this case, the boost phase B and the subsequent support phase S is explained as embodied in FIG. 2. However, different than the previously described case, here no neutral phase N is performed with a passive support, because the pedal value is below the above-mentioned limit of 90%, particularly of 95%, preferably of 100%. Rather, after the support phase S in the control phase D, the torque M_EM of the electric engine 14 is controlled with a defined gradient up to a negative torque (generator). In the charging phase L, similar to FIG. 2, the torque M_EM of the electric motor is determined according to the actual requirements of the vehicle power requested by the energy management. Here, too, subsequently another lowering of the torque M_EM of the electric motor can occur, in order to ensure a charging of the energy storage 22.

In the drive situation according to FIG. 4, a partial load situation is given, i.e., at to the requested desired torque M_W is below the maximum torque M_VM of the internal combustion engine and the pedal value PW is relatively low (for example 20%). In order to show the desired torque in a time as short as possible, the relatively inert torque M_VM of the internal combustion engine 12 is again supported in the initial boost phase B by a dynamic torque M_EM of the electric engine passing a maximum. In contrast to the above-described situation in this case however a lower boost torque of the electric engine 14 is sufficient. The boost phase B lasts at least until the requested torque M_W is reached. Due to the fact that in the present partial load situation the entire desired torque M_W can be represented by the internal combustion engine 12, subsequent to the boost phase B no additional support by the electric engine is necessary. However, at the time to the torque M_EM is controlled (generator operation) with a defined rate to a negative value. The torque M_EM controlled in the subsequent charging phase L can be selected even lower depending on SOC and/or SOH of the energy storage 22 either for covering the actual demand of the vehicle power (according to FIGS. 2 and 3) or to charge the energy storage 22. In order to compensate the braking moment achieved in this manner the torque M_VM of the internal combustion engine is correspondingly increased during the charging phase L. Subsequent to the charging phase L, in an acceleration phase H, an acceleration of the torque M_EM of the electric motor up to the zero-torque occurs and a corresponding control of the torque M_VM of the internal combustion engine. However, if at the time t₁ the energy storage 22 is fully charged or exceeds the charging condition of a predetermined limit and no or only little demand for vehicle power is given, the charging phase L can be omitted entirely and the boost phase B can directly be switched into the neutral phase N, in which the electric engine 14 is switched off.

The three above-mentioned strategies can be summarized in the following table:

| | Boost | | Neutral |
|---|---|---|---|
| | phase (B) | Second phase (S, L) | phase (N) |
| Full-load boost | Yes | Supporting phase (S), | Yes |
| M_W > M_VMmax | Maximum | motorized phase of the | |
| PW = 90...100% | boost | electric engine | |
| High-load boost | Yes | Supporting phase (S), | No |
| M_W > M_VMmax | Maximum | motorized phase of the | |
| PW < 90% | boost | electric engine | |
| Partial-load boost | Yes | Charging phase (L), | Yes |
| M_W < M_VMmax | Low boost | Generator operation of | |
| | | the electric engine or | |
| | | neutral phase (N) | |
| | | Electric engine “off” | |

### LIST OF REFERENCE CHARACTERS

10 hybrid drive unit
12 internal combustion engine
14 electric engine
16 transmission
18 drive lane
20 coupling or double coupling unit
22 energy storage/battery
24 power electronic
26 additional coupling
28 motor control device
30 torque control
32 pedal value sensor
n rotation
PW pedal value
M_EM torque of the electric motor
M_VM torque of the internal combustion engine
M_VMmax maximum torque of the internal combustion engine
M_Fzg total driving torque
M_W requested torque
M_Wmax maximum requested torque
B boost phase
S support phase
N neutral phase
L charging phase
D control phase
H acceleration phase

What is claimed is:

1. A method for controlling the torque of a motor vehicle with a hybrid drive unit, which comprises an internal combustion engine, as well as at least one, electric engine which can be operated in motor- or generator-mode, with the electric engine providing a positive and/or negative torque, which together with a torque of the internal combustion engine represents a total driving torque of the drive unit, the method comprising the steps of:
at the presence of a requested torque which is greater than an actually provided total driving torque of the drive unit:
in an initial boost phase, impressing a dynamic, positive torque of the electric engine on the torque of the internal combustion engine, which during the boost phase passes a maximum, and
in a second phase, for a predetermined duration, impressing a predetermined, essentially constant, positive or negative torque of the electric engine on the torque of the internal combustion engine so that the resulting total driving torque is at least almost equivalent to the requested torque, in which the algebraic signs and/or the strength of the torque of the electric engine are predetermined depending on the requested torque.

2. The method according to claim 1, wherein, when the requested torque is greater or equal to a maximum torque of the internal combustion engine, the second phase is performed as a supporting phase, in which the electric engine is operated motorized with a positive torque of the electric engine.

3. The method according to claim 1, wherein in the event the requested torque is lower than the maximum torque of the internal combustion engine, the second phase is performed as charging phase, in which the electric engine is operated in generator mode with a negative torque of the electric engine.

4. The method according to claim 1, wherein the duration of the second phase and/or the strength of the torque of the electric engine during the second phase is preset depending on the charging condition and/or the aging condition of an electric energy storage of the electric machine.

5. The method according to claim 1, wherein the duration of the second phase and/or the strength of the torque of the electric engine during the second phase is preset depending on the actual rotation of a particularly common camshaft of the hybrid drive unit.

6. The method according to claim 1, wherein the requested torque is stronger or equal to a maximum torque of the internal combustion engine, the boost phase is performed until a maximum torque of the internal combustion engine is reached.

7. The method according to claim 1, wherein in the event the requested torque is lower than the maximum torque of the internal combustion engine the boost phase is at least performed until a total driving torque is reached essentially equivalent to the requested torque.

8. The method according to claim 1, wherein the requested torque is stronger than the maximum torque of the internal combustion engine, in particular when simultaneously a pedal value of a pedal value sensor amounts to 90 to 100%, preferably 95 to 100%, a neutral phase is performed subsequent to the second phase, in which the electric engine is at least approximately operated with a zero-torque.

9. The method according to claim 1, wherein during the boost phase the torque of the internal combustion engine and the torque of the electric engine are controlled such that an at least almost maximum acceleration of the total driving torque results.

10. A torque control device of a motor vehicle with a hybrid drive unit which comprises an internal combustion engine as well as at least one electric engine which can be operated in a motor- or generator-mode, with the electric engine providing a positive and/or a negative torque of the electric engine, which together with a torque of an internal combustion engine represents a total driving torque of the drive unit, wherein the torque control device, when a requested torque is given that is stronger than the actually provided total driving torque of the drive unit, is designed to:
in an initial boost phase, impress on the torque of the internal combustion engine a dynamic, positive torque of the electric engine, which passes a maximum during the boost phase, and
in a second phase for a predetermined duration impresses a predetermined, essentially constant, positive or negative torque of the electric engine on the torque of the internal combustion engine so that the resulting total driving torque is at least almost equivalent to the requested torque, with algebraic signs and/or strength of the torque of the electric engine being preset depending on the requested torque.

11. A torque control device according to claim 10, wherein the internal combustion engine is provided with compressed charging air, in particular via an exhaust turbo charger.

12. A torque control device of a motor vehicle with a hybrid drive unit which comprises an internal combustion engine as well as at least one electric engine providing a positive and/or a negative torque, which together with a torque of an internal combustion engine represents a total driving torque of the drive unit, wherein when a requested torque is stronger than the actually provided total driving torque of the drive unit, the torque control device controls the electric engine:
to impress, in an initial boost phase, on the torque of the internal combustion engine a dynamic, positive torque, which passes a maximum during the boost phase, and
to impress, in a second phase for a predetermined duration, a predetermined, essentially constant, positive or negative torque on the torque of the internal combustion engine so that the resulting total driving torque is approximately equivalent to the requested torque, with algebraic signs and/or strength of the torque of the electric engine being preset depending on the requested torque.

13. A torque control device according to claim 12, wherein the internal combustion engine is provided with compressed charging air, in particular via an exhaust turbo charger.

14. The torque control device according to claim 12, wherein, when the requested torque is greater or equal to a maximum torque of the internal combustion engine, the second phase is performed as a supporting phase, in which the electric engine is operated motorized with a positive torque of the electric engine.

15. The torque control device according to claim 12, wherein in the event the requested torque is lower than the maximum torque of the internal combustion engine, the second phase is performed as charging phase, in which the electric engine is operated in generator mode with a negative torque of the electric engine.

16. The torque control device according to claim 12, wherein the duration of the second phase and/or the strength of the torque of the electric engine during the second phase is preset depending on the charging condition and/or the aging condition of an electric energy storage of the electric machine.

17. The torque control device according to claim 12, wherein the duration of the second phase and/or the strength of the torque of the electric engine during the second phase is preset depending on the actual rotation of a particularly common camshaft of the hybrid drive unit.

18. The torque control device according to claim 12, wherein the requested torque is stronger or equal to a maximum torque of the internal combustion engine, the boost phase is performed until a maximum torque of the internal combustion engine is reached.

19. The torque control device according to claim 12, wherein in the event the requested torque is lower than the maximum torque of the internal combustion engine the boost phase is at least performed until a total driving torque is reached essentially equivalent to the requested torque.

20. The torque control device according to claim 12, wherein the requested torque is stronger than the maximum torque of the internal combustion engine, in particular when simultaneously a pedal value of a pedal value sensor amounts to 90 to 100%, preferably 95 to 100%, a neutral phase is performed subsequent to the second phase, in which the electric engine is at least approximately operated with a zero-torque.

21. The torque control device according to claim 12, wherein during the boost phase the torque of the internal combustion engine and the torque of the electric engine are controlled such that an at least almost maximum acceleration of the total driving torque results.
